(19) United States
(12) Patent Application Publication
(10) Pub. No.: US 2009/0213071 A1
(43) Pub. Date: Aug. 27, 2009

(54) CONTROL SYSTEM AND METHOD FOR A CURSOR IN DISPLAY DEVICE

(75) Inventors: Zhongqing Li, Beijing (CN); Dongyang Wang, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: Lenovo (Beijing) Limited, Beijing (CN)

(21) Appl. No.: 11/722,127

(22) PCT Filed: Jul. 11, 2005
(86) PCT No.: PCT/CN05/01020

§ 371 Date: Feb. 27, 2009

(30) Foreign Application Priority Data
Dec. 22, 2004 (CN) 200410102417.5

(51) Int. Cl. G09G 5/08

(52) U.S. Cl. 345/158

(57) ABSTRACT

The present invention discloses a control system for a cursor in display device, in which said display device is connected to a data processing device and said system comprises: an image acquisition device for acquiring user image information and sending a signal; a signal receiving unit for receiving the signal from the image acquisition device; a signal processing unit for parsing said signal and determining whether the cursor and the target region the cursor reaches need to be shifted or not; and a cursor control unit for sending a cursor control signal to said display device based on the determination result by the signal processing unit and shifting the cursor to said target region. Accordingly, the present invention further discloses a control method for a cursor in a display device.

### BACKGROUND OF THE INVENTION

1. Field of Invention

The present invention relates to electronic information and data processing technology, in particular to a control system and method for a cursor in display device.

2. Description of Prior Art

With the evolution of industry automatization, the coverage of network expands, the data processing capability of computer advances, and the volume of information needed to be received mounts rapidly. So the use of one or more large display devices serves as one of the means to improve work efficiency. Unfortunately, this causes the situation that a cursor has to move over a long distance on a display screen and thus gives rise to problems such as inconvenient operability and fatigue proneness of wrist.

Currently, a computer operating system can support as many as 8 display devices simultaneously. And the number keeps growing with the progress of the technology. Many work stations are equipped with display devices counted up to 6 or even more. In this case, even if these display devices are arranged in two lines, a cursor has to move over a distance of about 1 m from an upper left corner to a lower right corner. If a conventional mouse or keyboard is utilized for control a cursor movement at such a long distance, the fatigue inflicted on a user's wrist will be aggravated, and any improvement in work efficiency will be adversely affected. Similar problems occur in the movement of a cursor for those who use large-screen personal computers or wide-screen notebook computers.

To overcome the drawback that a cursor has to move a too long distance, some of users adopt a hot key shifting method. The method, however, still requires a user to control with an additional wrist and sometimes needs the assistance of the user's eyes to check the position of hot keys on a keyboard. This impairs work efficiency and thus cannot provide a good solution to the above problems.

Some technical solutions, in which a cursor is controlled by using some newly-designed devices, have been known in the prior art, for example, those solutions disclosed in Chinese Patent Applications No. 02101980, 02141365 and 99800299. These devices resemble a mouse or a game joystick and need the manipulation of user by hands to move and locate a cursor based on the movement. Consequently, these solutions cannot solve the above problems either.

In the prior art there also exist some technical solutions in which a cursor is controlled by applying image processing technology, for example, those published in Chinese Patent Applications No. 03224405, 01110375 and 99111508.

The technical solution described in the patent No. 03224405 consists of manipulating a mobile point light source generator to locate its optical signal at different positions of a light source propagation medium, imaging and converting the signal by a CCD image sensor, analyzing and processing the signal by a processor and controlling the movement of a cursor on a display screen of an output device by a direction detector. The prior art, however, also needs a user to operate the mobile point light source generator and hence cannot solve the above problems satisfactorily.

The technical solution described in the patent No. 99111508 includes inputting a linear image and generating an image signal by an image input apparatus, converting the image signal into a position coordinate by an image processing circuit, and producing a cursor control signal based on the position coordinate. This method can barely meets the requirement of shifting a cursor quickly among multiple screens or among different regions on one display device. In addition, it may incur a problem of occupying too much resource of a computer.

The technical solution described in the patent No. 01110375 comprises: selecting an image by a photoelectric mechanism for receiving an image signal, processing the selected image and controlling accordingly the movement of a cursor on a screen or a display by a controller. Like the method in previous paragraph, this approach cannot meet the requirement of shifting a cursor quickly among multiple screens or among different regions on one display device neither, and may lead to a situation of occupying too much resource of a computer.

Further, the prior art mentioned above can only control the movement of cursor position, while it cannot fulfill the need for activating an application window in a target region at the time of moving a cursor.

### SUMMARY OF THE INVENTION

The object of the present invention is to provide a control system and a method for a cursor in display device, which can enable a quick shift of the cursor so as to effectively improve the work efficiency of a user and alleviate the fatigue on the wrist of the user.

The preset invention can also activate an application window in a target region while shifting the position of the cursor.

Therefore, a technical solution for solving the above problems according to the present invention is to provide a control system for a cursor in a display device, said display device is connected to a data processing device, and said system comprises:

an image acquisition device for acquiring user image information and sending a signal;
a signal receiving unit for receiving the signal from the image acquisition device;
a signal processing unit for parsing said signal and determining whether the cursor and the target region the cursor reaches need to be shifted or not; and
a cursor control unit for sending a cursor control signal to said display device based on the judgment result by the signal processing unit and shifting the cursor to said target region.

Preferably, the system further comprises a window activation unit for sending a window activation signal to said display device when an application window exists in said target region and activating the application window.

Preferably, said signal receiving unit, said signal processing unit, said cursor control unit and said window activation unit are elements separate from each other or at least two of them are integrated together.

Preferably, said signal receiving unit, said signal processing unit, said cursor control unit and said window activation unit are provided inside said data processing device.

Preferably, said signal receiving unit, said signal processing unit, said cursor control unit and said window activation unit constitute a control software system of said data processing device.

Preferably, said signal processing unit is provided inside said image acquisition device, while said signal receiving unit, said cursor control unit and said window activation unit are provided inside said data processing device.

Preferably, the target region determined by said signal processing unit is one of multiple display devices or one of multiple screen regions in a display device.

Preferably, the user image information acquired by said image acquisition device is user facial feature, and said signal processing unit makes a determination based on the current facial feature and a preset reference facial feature.

Preferably, said image acquisition device is provided inside said display device or said data processing device.

The present invention further provides a control method for a cursor in a display device, said display device is connected to a data processing device, and said method comprises steps of:

1) acquiring current user image information;
2) comparing and analyzing said current image information and determining whether the range for changing the cursor has achieved or not; if yes, proceeding to step 3); otherwise returning to said step 1); and
3) displaying the cursor in a target region corresponding to the current user image information.

Preferably, said method further comprises a step of acquiring the reference user image information before said step 1), and the comparing and analyzing in said step 2) comprises determining whether the user's sight line has changed or not based on the difference between the current image information and the reference image information.

Preferably, said method further comprises a step of checking the number of display devices or a step of setting the screen region of a display device before said step 1).

Preferably, said method further comprises activating an application window in the target region that the cursor reaches.

Preferably, said image information is user facial feature.

Compared with the prior art, the present invention is advantageous in that the cursor on the display device is controlled, for example controlled to rapidly shift, based on the processed information obtained by acquiring and processing the user image information so that the user can quickly shift the cursor among multiple display devices or change the position of the cursor on a display device. Consequently, the time for moving the cursor over a large distance by the user can be reduced, work efficiency can be improved, and the fatigue caused onto the user by operating the cursor at a large distance can be alleviated.

In a preferred embodiment of the present invention, it is further determined in a real-time fashion whether an application window exists in said target region or not; if yes, the application window can be activated. In this way, the user's work efficiency can be further enhanced, and the user Will feel more comfortable since the computer can grasp the user's intention from the direction of the user facial feature, such as eyes, which represents the object that the user wants to operate.

According to the present invention, for the existing notebook computer having a built-in PC camera, it can be realized without any increase in hardware cost that a cursor is shifted at a long distance on one or more screens and an application window in the target region is activated.

In conclusion, the present invention is a computer aided tool which shifts the position of a cursor and activates an application window in the target region by processing the orientation of a user's face. Furthermore, the present invention possesses a great practicability and is suitable for users at different ages.

### BRIEF DESCRIPTION OF THE DRAWINGS

FIG. 1 is a block diagram of a control system for the position of a cursor in display device according to the present invention;

FIG. 2 is a block diagram of a data processing device in the control system according to the present invention;

FIG. 3 is a flowchart for a control method according to the present invention;

FIG. 4 is a schematic diagram for components in the first embodiment of the control system according to the present invention;

FIG. 5 is a schematic diagram for parts of the control software system in the computer mainframe shown in FIG. 4;

FIG. 6 is a schematic diagram for partitions in the display shown in FIG. 4; and

FIG. 7 is a schematic diagram of the screen and the PC camera in the second embodiment of the present invention.

### DETAILED DESCRIPTION OF PREFERRED EMBODIMENTS

The present invention is a computer aided system that executes the steps of acquiring user image information, processing the user image information and controlling the position of a cursor in a display device based on the processed information. The present invention can further activate an application window Within a target region.

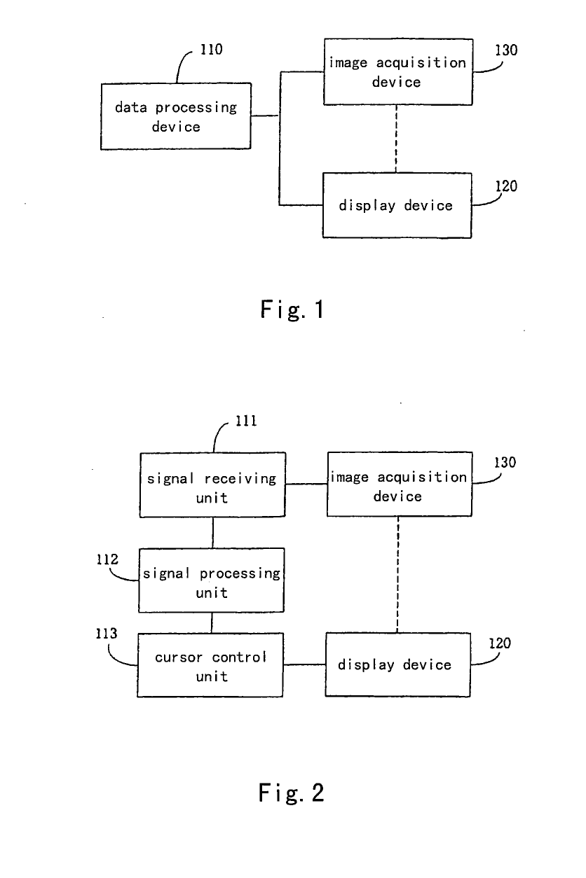

Referring to FIG. 1, the control system for the position of a cursor in a display device according to the present invention is configured to control a cursor displayed on a display device 120 and include a data processing device 110 and an image acquisition device 130. The data processing device 110 is connected to and controls the display device 120 and the image acquisition device 130.

The display device 120 receives data from the data processing device 110 and displays it under the control of the data processing device 110.

The image acquisition device 130 captures user image information and sends it to the data processing device 110.

Now referring to FIG. 2, the data processing device 110 includes a signal receiving unit 111, a signal processing unit 112 and a cursor control unit 113. The signal receiving unit 111 receives a signal from the data acquisition device 130 and sends it to the signal processing unit 112, which in turn processes said signal, determines the target region that the user wants the cursor to move to and sends a message to the cursor control unit 113. Based on said message, the cursor control unit 113 sends a cursor control signal to the display device 120 and adjusts the cursor to the corresponding region.

In addition, said data processing device 110 also includes a window activation unit 114 for the purpose of automatically activating an application window in the target region. Following the determination of the target region to be reached by the cursor from the signal processing unit 112, the window activation unit 114 determines whether an application window exists in this target region or not; if yes, sending a window activation signal to the display device 120 to activate the application window; otherwise, the system keeps running normally.

It should be noted that there can be one or more display devices 120, and the data processing device 110 controls the cursor to be displayed in the target region of these display devices 120. One or more image acquisition devices 130 can also be used, with each of them accepting the control of and communicating with the data processing device 110.

It should be further noted that the signal receiving unit 111, the signal processing unit 112, the cursor control unit 113 and the window activation unit 114 can be implemented in hardware or in software. In the latter case, their corresponding functions can be realized by executing associated software by the data processing device 110. These units can be separate from each other, or two or more of them can be integrated as a whole.

It will be envisaged that the image acquisition device 130 can be an independent element or integrated in the display device 120 or the data processing device 110.

It will be envisaged that the signal processing unit 112 can be integrated in the image acquisition device 130. In this case the signal receiving unit 111 receives data which has been processed by the signal processing unit 112.

In the embodiment of the present invention, the data processing device is an electronic device capable of data processing, which includes, but not limited to, desktop computer, notebook computer and the like; the display device is an electronic device having display function, which includes, but not limited to, Cathode Ray Tube (CRT) display, liquid crystal display, plasma display, field effect transistor display and the like; the image acquisition device is an electronic device capable of imaging an image, which includes, but not limited to, digital camera, PC camera, CCD, etc.

The user image information can be the orientation of the user's face from which the signal processing unit determines the target region for the cursor. It is obvious that the image information can also be other facial features including the user's viewing angle and the like.

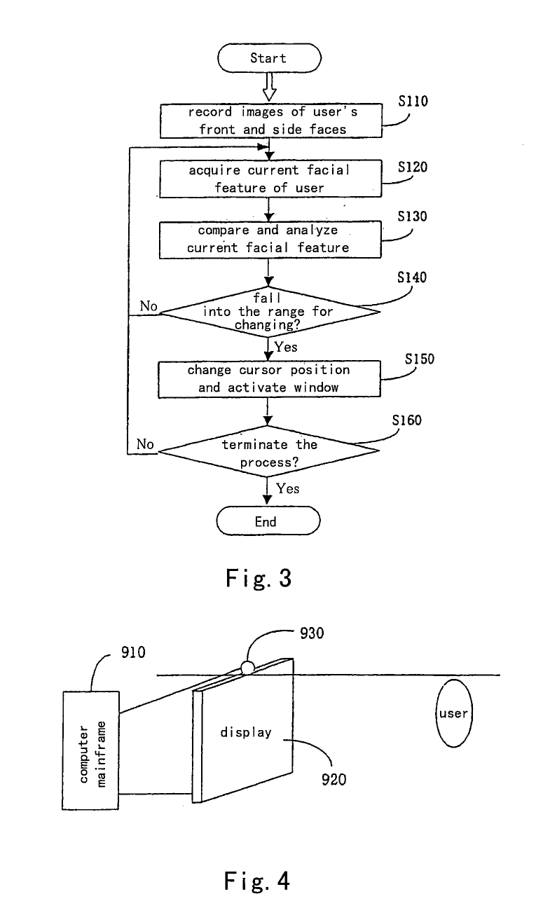

Next, the flow of the control method according to the present invention will be explained with reference to FIG. 3.

At step S110, the images of the user's front and side faces are recoded. This step determines the reference used in comparing and analyzing the user image information at the subsequent steps.

At step S120, the current facial feature of the user is acquired.

At step S130, the current facial feature is compared and analyzed.

At step S140, it is determined whether the range for changing is reached or not; if yes, the flow proceeds to step S150; otherwise the flow returns to step S120. Here, the step of determining finds out the difference between the current facial feature and the image information recoded in step S110, so it can be determined that the position of the cursor needs to be adjusted when a noticeable change occurs in the orientation of the user's face due to, for example, a significant deflection of the user's head.

At step S150, the position of the cursor is changed, that is, the position where the cursor is displayed is adjusted to the target region corresponding to the current facial feature of the user.

At step S160, it is determined whether to terminate the flow or not; if not, the flow returns to step S120; otherwise the flow is ended.

In addition, the invention can automatically activate an application window in the target region. The description thereof is omitted here.

In order to facilitate a clear understanding, the present invention will be illustrated by way of embodiment as follows.

Referring to FIG. 4, a rapid cursor shifting can be achieved in the existing wide-screen computer by use of the technical solution of the invention.

The system of this embodiment comprises a computer mainframe 910, a display 920 connected to the computer mainframe and a PC camera 930 connected to the computer mainframe, with a control software system (not shown) being provided in the computer mainframe 910. The PC camera 930 can be disposed above the display 920 and utilized to acquire a user's facial feature in a real-time fashion.

The control software system executed in the computer mainframe 910 has the primary functions of image acquisition, image pattern recognition, controlling the position of the cursor on the display 920 and activating an associated application window.

At first, the PC camera 930 records the facial feature of a user when his or her faces the display directly. If the user deflects his or her head to some large extent, the image acquired by the PC camera 930 is processed by the control software system to determine the target region to be reached by the cursor as the user desires and then adjust the cursor to the corresponding region. Meanwhile, an application window will be activated if it is located within this region. To prevent the cursor from being displaced due to a slight unintended rotation of the user's head, certain delay is applied to the shift of the cursor during an actual implementation such that the associated reaction is not too sensitive to result in some unwanted trouble.

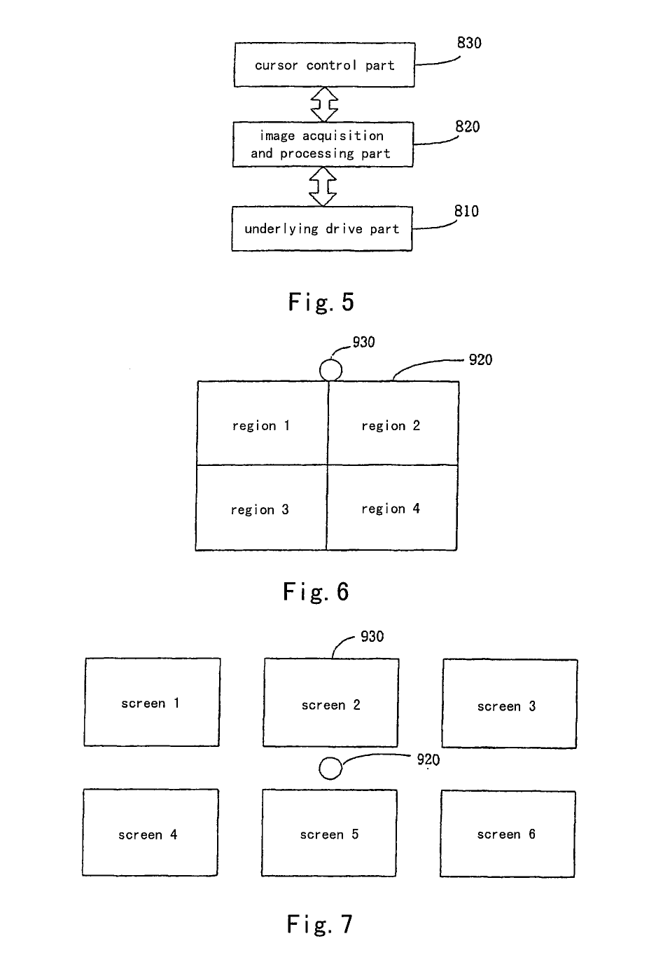

Now turning to FIG. 5, this figure is a block diagram for parts of the control software system. The control software system comprises an underlying drive part 810, an image acquisition and processing part 820 and a cursor control part 830. The underlying drive part 810 contains two parts, namely, a PC camera device driving module and a display driving module, which mainly provide associated invoking interface to the upper image acquisition and processing part 820 and control the PC camera and the display.

When the control software system starts to operate, what goes first is to acquire the image of a user's front face and to check the number of the display regions (to select the partitions of a screen if there is only one display, assuming there are 4 or more partitions in this embodiment), as shown in FIG. 6. The control software system considers the screen to be partitioned into 4 regions by default, and the difficulty in moving over a long distance emerges when the cursor is shifted from the region 1 to the region 4. According to the invention, however, the difficulty can be overcome and work efficiency can be remarkably boosted by processing the PC camera-acquired user facial feature by the control software system and shifting the position where the cursor lies based on the processed signal.

It should be noted that the resolution and pixel value of a screen serve as the predominant reference factors for dividing the screen into 4 or more regions. Although the screen can be divided into a large number of regions depending on these reference factors, it is appropriate to divide the screen into 4 regions with consideration of precision.

The control software system subsequently records the images of the user's face as the user views these regions in a frontal way, respectively, and processes these images as reference.

During operation, the control software system acquires a real-time image of the user's face and compares it with the recoded reference. When the comparison result falls into the range for a cursor shift, certain processing is carried out according to a prescribed cursor control strategy. Then, if the position of the cursor does need to be shifted, it will be changed by the cursor control part 830. Meanwhile, an application window will be activated if it exists in the target region. The cursor control strategy is mainly responsible for handling some problems encountered in real use, such as those related to unintended movement or quick rotation of the user's head. As for image processing, the feature associated with a three-point part, that is, the part between the user's eyes and nose, usually serves as the reference.

It should be noted that the above is described in a defaulted case where there is only one PC camera and the PC camera is disposed in the direct front of the user. In practice, there can be a plurality of PC cameras, each being connected to the computer mainframe and controllable by the control software system.

When the PC camera is not in the direct front of the user or there are multiple PC cameras, the control software system operates substantially in the same manner to that mentioned above, except that the PC cameras will be numbered at the initial stage of the software. If the deflection angle of the PC camera is large, the feature between the eyes, ears and nose of the user can be used as the reference in image processing.

Now referring to FIG. 7, a quick cursor shift can be achieved by adopting the technical solution of the present invention while a work station is monitoring.

Since there are various tasks that the work station has to monitor, a plurality of display screens are utilized, with each of them corresponding to a different task. As an example, six screens are arranged evenly around a PC camera in this embodiment.

As shown in FIG. 7, the moving distance of a cursor will amounts to about 1 m if the cursor is moved from the screen 1 to the screen 6, and such long-distance movement is troublesome for a user. On the contrary, with the application of the inventive method in which the facial feature of the user is processed and utilized, the cursor can be shifted to its destination within a short period plus a predetermined delay, which lasts for less than 0.5 s, when the user turns his or her face from the screen 1 to the screen 6. At the same time, an application window is also activated in the target region.

In summary, the key point of the present invention is to provide a computer aided system which enables a user either to shift a cursor quickly among multiple display devices and activate an application window in a target region or to change the position of a cursor rapidly on a single display device and activate an application window in a target region. The technical concept of the present invention is based on the fact that most of notebook computers marketed currently have been equipped with built-in PC cameras, and many desktop computers are also installed with PC cameras due to users' various demands, such as video chatting, video conferencing, etc. When a user wants to switch the current screen to another, the user will definitely turns his or her head to the target screen, which results in some change in the facial feature of the user imaged by the PC camera. By incorporating the image taken by the PC camera and the current powerful image processing technique, the facial feature of the user can be accurately analyzed and compared. After that, the destination to be reached by the cursor can be determined based on the analyzed and processed information. Finally the cursor is shifted to the destination quickly. With this method, the user can easily move the cursor over a large distance without manipulating any peripheral device, such as mouse or keyboard, with his or her hands. This can alleviate the fatigue on the wrist and improve work efficiency.

The above describes only the preferred embodiments of the invention. It will be appreciated for those skilled in the art that various modification and refinement can be made in the principle of the present invention, and these modification and refinement should fall into the scope of the present invention.

1-20. (canceled)

21. A control system for a cursor in display device, in which said display device is connected to a data processing device and said system comprises:
an image acquisition device for acquiring user image information and sending a signal;
a signal receiving unit for receiving the signal from the image acquisition device;
a signal processing unit for parsing said signal and determining whether the cursor and a target region the cursor reaches need to be shifted or not; and
a cursor control unit for sending a cursor control signal to said display device based on the determination result by the signal processing unit and shifting the cursor to said target region.

22. The control system for a cursor in a display device according to claim 21, further comprising a window activation unit for sending a window activation signal to said display device when an application window exists in said target region and activating the application window.

23. The control system for a cursor in a display device according to claim 22, wherein said signal receiving unit, said signal processing unit, said cursor control unit and said window activation unit are elements separate from each other or at least two of them are integrated together.

24. The control system for a cursor in a display device according to claim 22, wherein said signal receiving unit, said signal processing unit, said cursor control unit and said window activation unit are provided inside said data processing device.

25. The control system for a cursor in a display device according to claim 24, wherein said signal receiving unit, said signal processing unit, said cursor control unit and said window activation unit constitute a control software system of said data processing device.

26. The control system for a cursor in a display device according to claim 21, wherein said signal processing unit is provided inside said image acquisition device, and said signal receiving unit, said cursor control unit and said window activation unit are provided inside said data processing device.

27. The control system for a cursor in a display device according to claim 21, wherein the target region determined by said signal processing unit is one of multiple display devices or one of multiple screen regions in a display device.

28. The control system for a cursor in a display device according to claim 21, wherein the user image information acquired by said image acquisition device is user facial feature, and said signal processing device makes a determination based on the current facial feature and a preset reference facial feature.

29. The control system for a cursor in a display device according to claim 28, wherein said image acquisition device is provided inside said display device or said data processing device.

30. A control method for a cursor in display device, in which said display device is connected to a data processing device, and said method comprises steps of:
1) acquiring current user image information;
2) comparing and analyzing said current image information and determining whether the range for changing the cursor has been achieved or not; if yes, proceeding to step 3); otherwise returning to said step 1); and
3) displaying the cursor in a target region corresponding to the current user image information.

31. The control method for a cursor in a display device according to claim 30, further comprising a step of acquiring the reference user image information before said step 1), and the comparing and analyzing in said step 2) comprises determining whether the user's sight line has changed or not based on the difference between the current image information and the reference image information.

32. The control method for a cursor in a display device according to claim 30, further comprising a step of checking the number of display devices or a step of setting the screen region of a display device before said step 1).

33. The control method for a cursor in a display device according to claim 30, further comprising activating an application window in the target region that the cursor reaches.

34. The control method for a cursor in a display device according to claim 30, wherein said image information is user facial feature.

35. The control system for a cursor in a display device according to claim 22, wherein the user image information acquired by said image acquisition device is user facial feature, and said signal processing device makes a determination based on the current facial feature and a preset reference facial feature.

36. The control system for a cursor in a display device according to claim 23, wherein the user image information acquired by said image acquisition device is user facial feature, and said signal processing device makes a determination based on the current facial feature and a preset reference facial feature.

37. The control system for a cursor in a display device according to claim 24, wherein the user image information acquired by said image acquisition device is user facial feature, and said signal processing device makes a determination based on the current facial feature and a preset reference facial feature.

38. The control system for a cursor in a display device according to claim 25, wherein the user image information acquired by said image acquisition device is user facial feature, and said signal processing device makes a determination based on the current facial feature and a preset reference facial feature.

39. The control system for a cursor in a display device according to claim 26, wherein the user image information acquired by said image acquisition device is user facial feature, and said signal processing device makes a determination based on the current facial feature and a preset reference facial feature.

40. The control system for a cursor in a display device according to claim 27, wherein the user image information acquired by said image acquisition device is user facial feature, and said signal processing device makes a determination based on the current facial feature and a preset reference facial feature.
